(19) United States
(12) Patent Application Publication
(10) Pub. No.: US 2023/0252279 A1
(43) Pub. Date: Aug. 10, 2023

(54) SELF-SUPERVISED BASED APPROACH FOR MITIGATING CATASTROPHIC FORGETTING IN CONTINUAL LEARNING

(71) Applicant: NavInfo Europe B.V., Eindhoven (NL)

(72) Inventors: Prashant Shivaram Bhat, Eindhoven (NL); Bahram Zonooz, Eindhoven (NL); Elahe Arani, Eindhoven (NL)

(21) Appl. No.: 17/667,364

(22) Filed: Feb. 8, 2022

(51) Int. Cl. G06N 3/08

(52) U.S. Cl. CPC G06N 3/08

(57) ABSTRACT

A two-stage computer-implemented method for continual learning intertwining task-agnostic and task-specific learning whereby self-supervised training is followed by supervised learning for each task. To further restrict the deviation from the learned representations in the self-supervised stage, a task-agnostic auxiliary loss is employed during the supervised stage.

### BACKGROUND OF THE INVENTION

### Field of the Invention

The invention relates to the deep neural network field, more particularly to a self-supervised based continual learning (CL) approach for mitigating catastrophic forgetting.

### Background Art

Autonomous agents interacting in the real world are exposed to continuous streams of information and thus are required to learn and remember multiple tasks sequentially. Continual Learning (CL) [17, 18] deals with learning from continuous stream of data with the goal of gradually extending the acquired knowledge to solve multiple tasks sequentially. CL is also referred to as Lifelong learning, sequential learning or incremental learning [17]. CL over continuous stream of data remains one of the long-standing challenges in deep neural networks (DNNs) as they are prone to catastrophic forgetting i.e., a tendency of deep neural networks to lose knowledge pertaining to previous tasks when the information relevant to the current task is incorporated. Catastrophic forgetting often leads to abrupt drop in performance, or in the worst case, old knowledge is completely overwritten by new information [18].

Several approaches have been proposed in the literature to address the problem of catastrophic forgetting in CL. Replay-based methods [2, 3] store and replay a subset of samples belonging to previous tasks along with the current batch of samples. The performance of replay-based methods is commensurate with the buffer size. Therefore, these methods leave a large memory footprint. Regularization-based methods [4, 5] insert a regularization term to consolidate the previous knowledge when training on new tasks. These methods avoid using memory buffer altogether alleviating the memory requirements. Parameter isolation methods [6] allocate distinct set of parameters to distinct tasks thereby minimizing the interference.

Although the aforementioned approaches have been partially successful in mitigating catastrophic forgetting, they still suffer from several shortcomings. Since CL methods rely extensively on cross-entropy loss for classification tasks, they are prone to lack of robustness to noisy labels [25] and the possibility of poor margins [26] affecting their ability to generalize across tasks. Furthermore, the optimization objective in cross-entropy loss encourages learning of representations optimal for the current task sidelining the representations that might be necessary for the future tasks, resulting in prior information loss [1]. Also, the representations of the observed tasks drift when new tasks appear in the incoming data stream exacerbating the backward interference. The inventors assume that task-specific learning is the root cause of several other problems and is not well-equipped to deal with catastrophic forgetting.

There have been efforts to combine self-supervised learning into CL. Gallardo et al (2021) [7] empirically showed that self-supervised pre-training yields representations that generalize better across tasks than supervised pre-training in CL. In many real-world CL scenarios however, the data distribution of the future tasks is not known beforehand. Pre-training on a different data distribution often leads to domain shift subsequently reducing the generalizability of the learned representations. Furthermore, longer task sequences diminish the effect of self-supervised pre-training as the learned representations are repeatedly overwritten to maximize the performance on the current task.

Owing to additional computational effort, some of the approaches (e.g. [8, 9]) relinquished pre-training altogether and employed auxiliary pretext task to boost task-agnostic learning. However, these approaches only show a marginal improvement over the baseline methods. To mitigate catastrophic forgetting further, it is pertinent to learn task-agnostic representations. However, an effective approach integrating SSL into CL is still missing.

Discussion of any references or publications herein is given for more complete background and is not to be construed as an admission that such references or publications are prior art for patentability determination purposes.

### BRIEF SUMMARY OF THE INVENTION

It is an object of the current invention to correct the shortcomings of the prior art by improving forward facilitation while reducing backward interference in continual learning. This and other objects which will become apparent from the following disclosure, are provided with a self-supervised learning method for continual learning in deep neural networks having the features of one or more of the appended claims.

According to a first aspect of the invention, the proposed method for continual learning over non-stationary data streams comprises a number of sequential tasks wherein for each task a training budget is allocated and wherein said training budget is divided into a task-agnostic learning phase and a task-specific learning phase.

Suitably, the task-agnostic learning phase is followed by the task-specific learning phase. These features help bridge the aforementioned shortcomings without the need for SSL pre-training.

The task-agnostic learning phase comprises a self-supervised learning phase. Self-supervised learning offers the advantages of learning task-agnostic, robust representations generalizable across multiple tasks.

Solving pretext tasks created from known information can help in learning representations useful for downstream tasks. The task-agnostic learning phase is, therefore, cast as an instance-level discrimination task wherein the task-agnostic learning phase comprises the steps of:
selecting a batch of N of random samples from a task-specific data distribution and from a data distribution stored in a memory buffer;
Creating two highly correlated views of the sample by passing each sample in a batch through a stochastic augmentation module
Creating positive and negative sets for each correlated view. The correlated views are used as positive samples while rest of the samples in a batch are treated as negatives for this positive pair.
Solving the instance discrimination pretext task through contrastive learning using aforementioned positive and negative pairs.

In order to align the task-agnostic representations to the current task, the task-specific learning phase comprises a supervised learning phase.

The interplay between task-agnostic and task-specific learning objectives can lead to sharp drift in the feature space and erode the generic representations learned during task-agnostic learning. Multi-objective learning offers a viable solution to address this trade-off. Multi-objective learning can be thought of as a form of inductive transfer and is known to improve generalization. It is also data efficient as multiple objectives are learned simultaneously using shared representations.

The task-specific learning phase comprises the step of training classification head with cross-entropy objective. To further restrict the deviation from the learned representations in the self-supervised phase, the supervised learning phase comprises of rotation prediction as a task-agnostic auxiliary loss function. Employing rotation prediction as an auxiliary loss preserves the task-agnostic features.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a diagram that summarizes a method according to an embodiment of the present invention.

### DETAILED DESCRIPTION OF THE INVENTION

Continual learning normally consists of T sequential tasks. During each task, the input samples and the corresponding labels (xₜ,yₜ) are drawn from the task specific data distribution Dₜ. Our continual learning model consists of a backbone network f_{θ} and three heads (h_{θ}^{ssl},h_{θ}^{cls},h_{θ}^{rot}). The continual learning model g_{θ}={f_{θ},h_{θ}^{ssl},h_{θ}^{cls},h_{θ}^{rot}} is sequentially optimized on one task at a time up to the current one t∈1, . . . , T_{c}. The objective function is therefore as follows:

L_{T}_{_{c}}=Σₜ₌₁^{T}^{_{c}} [symbol] ₍ₓ_{ₜ}_{,y}_{ₜ}_{)˜D}_{ᵣ}[l_{ce}(σ(h_{θ}^{cls}(f_{θ}(xₜ))),yₜ)] (Eq. 1)

where σ is a softmax function and l_{ce} is a classification loss, generally a cross-entropy loss. Continual learning is especially challenging since the data from the previous tasks are unavailable i.e. at any point during training, the model g_{θ} has access to the current data distribution Dₜ alone. As the objective function in Eq. (1) is solely optimized for the current task, it leads to overfitting on the current task and catastrophic forgetting of older tasks. Replay-based methods sought to address this problem by storing a subset of training data from previous tasks and replaying them alongside current task samples. For replay-based methods, Eq. (1) can thus be rewritten as:

L_{cls}=L_{T}_{_{c}}+ [symbol] ₍ₓ_{ₜ}_{,y}_{ₜ}_{)˜D}_{ᵣ}[l_{ce}(σ(h_{θ}^{cls}(f_{θ}(xₜ))),yₜ)] Eq. 2

where Dᵣ represents the distribution of samples stored in the buffer. Although cross-entropy loss is widely used for classification tasks in continual learning, it suffers from several shortcomings such as lack of robustness to noisy labels and the possibility of poor margins, affecting the ability to generalize across tasks. Self-supervised learning offers an alternative by learning task-agnostic, robust, and generalizable representations. Therefore, a two-stage training consisting of task-agnostic learning followed by task-specific learning can help bridge the aforementioned shortcomings without the need for pre-training.

### Task-Agnostic Learning Phase:

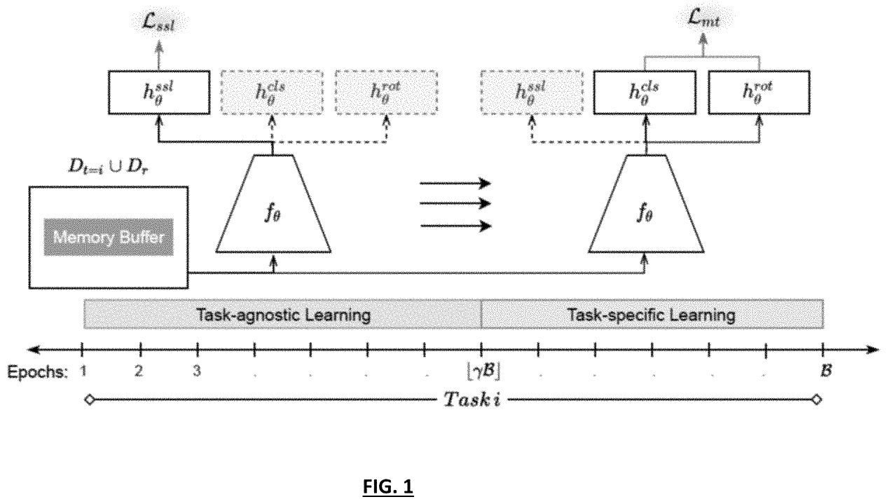

The task-agnostic learning phase of the disclosed method, as depicted in FIG. 1, is casted as an instance-level discrimination task. For a set of N randomly sampled images, each image is passed through two sets of augmentations a′, a″˜A producing 2N images per minibatch. Therefore, each image within 2N samples will have a unique positive pair and 2(N−1) negative samples. Let Z=h_{θ}^{ssl}(f_{θ}(.)) be a projection matrix of 2N augmented samples and sim(.,.) denote cosine similarity. The self-supervised contrastive loss for a positive pair of examples (i,j) is defined as:

$$l ( i , j ) = - log \frac{{e}^{s i m ( {z}_{i} , {z}_{j} ) / {T}_{c}}}{{Σ}_{k = 1}^{2 N} {𝕝}_{[ k \neq i ]} {e}^{( {z}_{i} , {z}_{k} ) / {T}_{c}}} \qquad ( Eq . 3 )$$

Contrastive learning in Eq. (3) learns visual representations by contrasting semantically similar (positive) and dissimilar (negative) pairs of data samples such that similar pairs have the maximum agreement via a contrastive loss in the latent space through Noise Contrastive Estimation (NCE). Given a limited training time for each task, it is pertinent to learn task-agnostic features that are in line with the class boundaries to avoid interference in the downstream tasks. Eq. 3 is then adapted to leverage label information. Within each minibatch, normalized embeddings belonging to the same class are pulled together while those belonging to other classes are pushed away in the latent space.

$${l}_{s s l} ( i , j ) = \frac{- 1}{\vert P ( i ) \vert} {Σ}_{p ∈ P ( i )} log \frac{{e}^{s i m ( {z}_{i} , {z}_{j} ) / {T}_{c}}}{{Σ}_{k = 1}^{2 N} {𝕝}_{[ k \neq i ]} {e}^{( {z}_{i} , {z}_{k} ) / {T}_{c}}} \qquad ( Eq . 4 )$$

where P(i) is a set of indices of samples belonging to the same class as the positive pair and |P(i)| is its cardinality. While Eq. 4 is a simple extension to contrastive loss, it eliminates the need for hard negative mining.

### Task-Specific Learning Phase:

To align the task-agnostic representations to the current task, the classification head h_{θ}^{cls} is trained with cross-entropy objective defined in Eq. 2. However, the interplay between task-agnostic and task-specific learning objectives can lead to sharp drift in the feature space and erode the generic representations learned during task-agnostic learning.

Multi-objective learning offers a viable solution to address this trade-off. Multi-objective learning can be thought of as a form of inductive transfer and is known to improve generalization. It is also data efficient as multiple objectives are learned simultaneously using shared representations.

Furthermore, a rotation prediction is employed as an auxiliary loss to preserve the task-agnostic features. During task-specific stage of each task, input samples x∈Dₜ∪Dᵣ are rotated by a fixed angle in addition to other transformations. The learning objective is to match task-specific ground truths y∈Dₜ∪Dᵣ as well as auxiliary ground truths y^{a}∈{0°,90°,180°,270°}, i.e.

Lₘₒ=αL_{cls}+β [symbol] _{x∈D}_{ₜ}_{∪D}_{ᵣ}[l_{ce}(σ(h_{θ}^{rot}(f_{θ}(x))),y^{a})] (Eq. 5)

where α and β are hyperparameters for adjusting the magnitudes of two losses.

Algorithm 1 summarizes the proposed method in detail.

Algorithm 1 The Proposed Method

```
      input: training budget [symbol]  and ratio 0 < 7 < 1, model
      g_{θ}
  1: for all tasks t ∈ {1, 2, . . ,T} do
  2: for e = 0: [γ [symbol]  ] do [symbol]  Task-agnostic Learning
  3: for minibatch (Xₘ,Yₘ)_{m = 1}^{M} ∈ [symbol] ₜ ∪ [symbol]  ᵣ do
  4: Draw augmentation functions α′, α″ ~ A
  5: X = {α′(Xₘ), α″(Xₘ)}
  6: Z = h_{θ}^{ssl}(f_{θ}(X))
  7:  ${ℒ}_{ssl} = \frac{1}{2 𝒩} {{\sum }^{𝒩}}_{k = 1} [ {l}_{ssl} ( 2 k - 1 , 2 k ) + {l}_{ssl} ( 2 k , 2 k - 1 ) ]$
  8: update the networks f_{θ} and h_{θ}^{ssl}
  9: for e = └γ [symbol]  ┘: [symbol]  do [symbol] Task-specific Learning
10: for minibatch (Xₘ, Yₘ)_{m = 1}^{M}∈ [symbol] ₜ ∪ [symbol]  ᵣ do
11: Draw rotation α ~ 0⁰, 90⁰, 180⁰, 270⁰
12: F = f_{θ}(α(Xₘ)
13: Z^{cls}, Z^{rot} = h_{θ}^{cls}(F), h_{θ}^{rot} (F)
14: Compute Lₘₒ
15: update the networks f_{θ}, h_{θ}^{cls} and h_{θ}^{rot}
16: update replay buffer [symbol] ᵣ
```

Embodiments of the present invention can include every combination of features that are disclosed herein independently from each other. Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

### REFERENCES

1. Song Zhang, Gehui Shen, and Zhi-Hong Deng. Self-supervised learning aided class-incremental lifelong learning. arXiv preprint arXiv:2006.05882, 2020
2. Pietro Buzzega, Matteo Boschini, Angelo Porrello, Davide Abati, and Simone Calderara. Dark experience for general continual learning: a strong, simple baseline. In Advances in Neural Information Processing Systems, volume 33, pages 15920-15930. Curran Associates, Inc., 2020.
3. Roger Ratcliff. Connectionist models of recognition memory: constraints imposed by learning and forgetting functions. Psychological review, 97(2):285, 1990
4. Jonathan Schwarz, Wojciech Czarnecki, Jelena Luketina, Agnieszka Grabska-Barwinska, Yee Whye Teh, Razvan Pascanu, and Raia Hadsell. Progress & compress: A scalable framework for continual learning. In International Conference on Machine Learning, pages 4528-4537. PMLR, 2018.
5. Friedemann Zenke, Ben Poole, and Surya Ganguli. Continual learning through synaptic intelligence. In Doina Precup and Yee Whye Teh, editors, Proceedings of the 34th International Conference on Machine Learning, volume 70 of Proceedings of Machine Learning Research, pages 3987-3995. PMLR, 06-11 Aug. 2017
6. Andrei A Rusu, Neil C Rabinowitz, Guillaume Desjardins, Hubert Soyer, James Kirkpatrick, Koray Kavukcuoglu, Razvan Pascanu, and Raia Hadsell. Progressive neural networks. arXiv preprint arXiv:1606.04671, 2016
7. Jhair Gallardo, Tyler L. Hayes, and Christopher Kanan. Self-supervised training enhances online continual learning, 2021
8. Pratik Mazumder, Pravendra Singh, and Piyush Rai. Fewshot lifelong learning. In Proceedings of the AAAI Conference on Artificial Intelligence, volume 35, pages 2337-2345, 2021
9. Jong-Chyi Su, Subhransu Maji, and Bharath Hariharan. When does self-supervision improve fewshot learning? In European Conference on Computer Vision, pages 645-666. Springer, 2020.
10. Gamaleldin Elsayed, Dilip Krishnan, Hossein Mobahi, Kevin Regan, and Samy Bengio. Large margin deep networks for classification. In Advances in Neural Information Processing Systems, volume 31. Curran Associates, Inc., 2018.
11. Sainbayar Sukhbaatar, Joan Bruna, Manohar Paluri, Lubomir Bourdev, and Rob Fergus. Training convolutional networks with noisy labels. In 3rd International Conference on Learning Representations, ICLR 2015, 2015
12. Prannay Khosla, Piotr Teterwak, Chen Wang, Aaron Sarna, Yonglong Tian, Phillip Isola, Aaron Maschinot, Ce Liu, and Dilip Krishnan. Supervised contrastive learning. arXiv preprint arXiv:2004.11362, 2020
13. Dan Hendrycks and Thomas Dietterich. Benchmarking neural network robustness to common corruptions and perturbations. In International Conference on Learningyo Representations, 2018
14. Fabian Kuppers, Jan Kronenberger, Amirhossein Shantia, and Anselm Haselhoff. Multivariate confidence calibration for object detection. In The IEEE/CVF Conference on Computer Vision and Pattern Recognition (CVPR) Workshops, June 2020.
15. Mandi Pakdaman Naeini, Gregory Cooper, and Milos Hauskrecht. Obtaining well calibrated probabilities using bayesian binning, 2015
16. Devansh Arpit, Stanislaw Jastrz ebski, Nicolas Ballas, David Krueger, Emmanuel Bengio, Maxinder S Kanwal, Tegan Maharaj, Asja Fischer, Aaron Courville, Yoshua Bengio, et al. A closer look at memorization in deep networks. In International Conference on Machine Learning, pages 233-242. PMLR, 2017
17. Delange, M., Aljundi, R., Masana, M., Parisot, S., Jia, X., Leonardis, A., . . . & Tuytelaars, T. (2021). A continual learning survey: Defying forgetting in classification tasks. IEEE Transactions on Pattern Analysis and Machine Intelligence.
18. Parisi, G. I., Kemker, R., Part, J. L., Kanan, C., & Wermter, S. (2019). Continual lifelong learning with neural networks: A review. Neural Networks, 113, 54-71.
19. Weiss, K., Khoshgoftaar, T. M., & Wang, D. (2016). A survey of transfer learning. Journal of Big data, 3(1), 1-40.
20. Newell, A., & Deng, J. (2020). How useful is self-supervised pretraining for visual tasks?. In Proceedings of the IEEE/CVF Conference on Computer Vision and Pattern Recognition (pp. 7345-7354).
21. Chen, T., Kornblith, S., Norouzi, M., & Hinton, G. (2020, November). A simple framework for contrastive learning of visual representations. In International conference on machine learning (pp. 1597-1607). PMLR.
22. Grill, J. B., Strub, F., Altché, F., Tallec, C., Richemond, P. H., Buchatskaya, E., . . . & Valko, M. (2020). Bootstrap your own latent: A new approach to self-supervised learning. arXiv preprint arXiv:2006.07733.
23. Vafaeikia, P., Namdar, K., & Khalvati, F. (2020). A Brief Review of Deep Multi-task Learning and Auxiliary Task Learning. arXiv preprint arXiv:2007.01126.
24. Xiao Liu, Fanjin Zhang, Zhenyu Hou, Zhaoyu Wang, Li Mian, Jing Zhang, and Jie Tang. Self-supervised learning: Generative or contrastive, 2020
25. Sainbayar Sukhbaatar, Joan Bruna, Manohar Paluri, Lubomir Bourdev, and Rob Fergus. Training convolutional networks with noisy labels. In3rd International Conference on Learning Representations, ICLR 2015, 2015.
26. Gamal Eldin Elsayed, Dilip Krishnan, Hossein Mobahi, Kevin Regan, and Samy Bengio. Large margin deep networks for classification. In Advances in Neural Information Processing Systems, volume 31. Curran Associates, Inc., 2018

1. A deep-learning based computer-implemented method for continual learning over non-stationary data streams comprising a number of sequential tasks (T) wherein for each task (t) a training budget (B) is allocated, wherein said training budget (B) is divided into:
a task-agnostic learning phase; and
a task-specific learning phase.

2. The method according to claim 1, wherein the task-agnostic learning phase is followed by the task-specific learning phase.

3. The method according to claim 1, wherein the task-agnostic learning phase comprises a self-supervised learning phase.

4. The method according to claim 1, wherein the task-specific learning phase comprises a supervised learning phase.

5. The method according to claim 1, wherein the task-specific learning phase comprises at least one task-agnostic auxiliary loss.

6. The method according to claim 1, wherein the task-agnostic learning phase is an instance-level discrimination task wherein the task-agnostic learning phase comprises the steps of:
selecting a number (N) of random samples from a task-specific data distribution and/or from a data distribution stored in a memory buffer;
at least doubling the number (N) of samples by passing each sample through at least two augmentations;
extracting at least one positive pair of samples;
extracting at least one negative pair of samples; and
solving a contrastive loss function for said positive and negative pairs.

7. The method according to claim 1, wherein the task-specific learning phase comprises the step of training a classification head with cross-entropy objective.

8. The method according to claim 7, wherein said at least one cross-entropy objective is based on experience replay.

9. The method according to claim 3, wherein the supervised learning phase comprises at least one task-agnostic auxiliary loss function.

10. The method according to claim 10, wherein the at least one task-agnostic auxiliary loss function comprises a rotation prediction.

11. The method according to claim 1, wherein the task-specific learning phase comprises the step of matching task-specific ground truths and auxiliary ground truths for adjusting a magnitude of the primary loss function and a magnitude of the auxiliary loss function.
